(19) United States
(12) Patent Application Publication
(10) Pub. No.: US 2009/0135189 A1
(43) Pub. Date: May 28, 2009

(54) Character animation system and method

(75) Inventors: Hang Kee Kim, Daejeon (KR); Chang Joon Park, Daejeon (KR); Kwang Ho Yang, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/232,919

(22) Filed: Sep. 26, 2008

(30) Foreign Application Priority Data
Nov. 22, 2007 (KR) 10-2007-0119878

(51) Int. Cl. G06T 13/00

(52) U.S. Cl. 345/473

(57) ABSTRACT

A character animation system includes a data generating unit for generating a character skin mesh and an internal reference mesh, a character bone value, and a character solid-body value, a skin distortion representing unit for representing skin distortion using the generated character skin mesh and the internal reference mesh when an external shock is applied to a character, and a solid-body simulation engine for applying the generated character bone value and the character solid-body value to a real-time physical simulation library and representing character solid-body simulation. The system further includes a skin distortion and solid-body simulation processing unit for processing to return to a key frame to be newly applied after the skin distortion and the solid-body simulation are represented.

### CROSS-REFERENCE(S) TO RELATED APPLICATIONS

The present invention claims priority of Korean Patent Application No. 10-2007-0119878, filed on Nov. 22, 2007, which is incorporated herein by reference.

### FIELD OF THE INVENTION

The present invention relates to a character animation system and method, and more particularly, to a real-time character animation system and method that consider a skin distortion and a physical phenomenon when an external shock is applied.

This work was supported by the IT R&D program of MIC/IITA[2006-s-044-02, Development of Multi-Core CPU & MPU-Based Cross-Platform Game technology]

### BACKGROUND OF THE INVENTION

Recent three-dimensional real-time graphics have been rapidly developed with enhancement and widespread utilization of related hardware. In particular, character animation has been widely used for games and educations, as well as simulations.

There have been several attempts for high-speed realistic representation in such character animation. Examples of a conventional animation method include an animation method using a key frame, an animation method using a motion capture, an animation method using anatomic data, an animation method using only a physical phenomenon, and a distortion method using SoftBody.

There are a conventional system and method for generating face animation using anatomic data and a conventional method for modeling a human body for character animation.

According to the conventional system for generating face animation using anatomic data. An anatomic data storage block stores skulls, skull geometric information, and muscle information corresponding to a plurality of face models. A muscle arranging block searches for, from the anatomic data storage unit, a skull most similar to an external input face model and arranges a predetermined number of muscles to the searched skull in order to generate the face animation. A skin generating block couples a subcutaneous fat layer and a skin to the skull with the muscle to generate a face mesh and defines a skin motion according to a muscle motion. An expression generating block shrinks or relaxes the muscle and the subcutaneous fat layer and the skin connected to the muscle on the generated face mesh in response to an external muscle adjustment signal, and generates and stores a face mesh having a specific expression.

The conventional method for modeling a human body for character animation includes a coordinate correction process of matching skeleton data of a multi-joint structure having links and joints and skin data of a three-dimensional polygonal model, with one coordinate system; a segmentation process of classifying the respective joints and skin data according to elements and calculating a bounding box for each element; and a binding process of inspecting respective elements of skin data and skeleton data and discovering and coupling skin data corresponding to the respective joints, resulting in a human body model in which the skin is adhered to the skeleton.

And, there is the conventional techniques perform animation by using a pre-formed key frame. Accordingly, they require a number of key frames depending on several situations and do not natually realize the animation at any specific situation.

Furthermore, there is a method for real-time character animation using a physical phenomenon. In this case, when a shock is applied, a character is regarded as a combination of solid bodies for simulation. This method is mainly used when there is no internal force in the character (i.e., when the object died or fainted), which is called Ragdoll simulation. This technique is supported by a conventional real-time physical simulation engine, such as Open Dynamics Engine (ODE), Havok, Physics X (PhysX), or the like.

However, these methods do not consider a character returning to a key frame (e.g., returning to its original posture after being struck), and also do not represent skin distortion caused by the shock.

### SUMMARY OF THE INVENTION

It is, therefore, an object of the present invention to provide a character animation system and method capable of representing skin distortion using an internal reference mesh, and representing simple animation, including animation of an object returning to its original posture after being struck, in real time using Ragdoll simulation and key frame interpolation.

In accordance with one aspect of the invention, a character animation system includes a data generating unit for generating a character skin mesh and an internal reference mesh, and a character bone value, and a character solid-body value, a skin distortion representing unit for representing skin distortion using the generated character skin mesh and the internal reference mesh when an external shock is applied to a character, and a solid-body simulation engine for applying the generated character bone value and the character solid-body value to a real-time physical simulation library and representing character solid-body simulation. The system further includes a skin distortion and solid-body simulation processing unit for processing to return to a key frame to be newly applied after the skin distortion and the solid-body simulation are represented. The skin distortion and solid-body simulation processing unit represents weighted blending between the character solid-body simulation and the key frame for real time representation by an equation: Ani(Character, t)=W(t)*Ani(solid-body simulation, t)+(1-W(t))*(key frame Ani, t), where W(t) is a weight of the character solid-body simulation at a time t, and (1-W(t)) is a weight of the key frame animation at a time t, and upon weighted blending, the skin distortion and solid-body simulation processing unit blends rotation values of respective joints using Spherical Linear interpolation (SLERP) with a weight, and blends location values through linear interpolation of the weight. The skin distortion representing unit has a spring structure in which edges between a vertex of the internal reference mesh and a vertex of the character skin mesh and between vertexes of the character skin mesh are spring, and represents laterally shoved skin, sunken skin, and stretched skin through animation. The edges have a predetermined spring constant and an initial mesh shape is regarded as a stable state. The skin distortion representing unit operates in proportion to a distance between a vertex of the character skin mesh and a corresponding vertex of the internal reference mesh, and represents the skin distortion by much accepting a skin distortion force and decreasing the size of force applied to solid-body simulation when the distance is long and by less accepting the skin distortion force and increasing the size of the force applied to the solid-body simulation when the distance is short. The internal reference mesh is generated by matching the character with a skeleton, a size of a muscle mesh, and a posture, discovering a point at which a distance between the skeleton and the muscle mesh at each skin vertex of the character is smallest, forming a virtual sphere around each skin vertex of the character, gradually increasing a radius of the sphere, stopping increasing the radius when a collision with the triangles of the skeleton and the muscle mesh occurs, taking the radius at this time as a thickness, storing a collision point to calculate a thickness between the skeleton and the muscle mesh at each skin vertex of the character, correcting the calculated thickness value using a painting unit, and using the corrected thickness value. The internal reference mesh is an internal threshold surface on which the skin is no longer sunken in representing the distortion of the character skin model. The internal reference mesh is invisible on a screen during actual rendering and used for controlling a motion in animation. The character solid-body simulation includes the solid body of the character and imposes limiting points to joint rotation. The character solid-body simulation takes a location, strength, and direction of force, as inputs.

In accordance with another aspect of the invention, a character animation method includes generating a character skin mesh for each vertex of the character, generating an internal reference mesh of a character, generating a bone value of the character, generating a solid body value of the character, representing skin distortion using the generated character skin mesh and the generated internal reference mesh, applying the generated character bone value and the generated character solid-body value to a real-time physical simulation library to represent character solid-body simulation, processing to return to a key frame to be newly applied after representing the skin distortion and the solid-body simulation. The internal reference mesh is generated by matching the character with a skeleton, a size of a muscle mesh, and a posture, discovering a point at which a distance between the skeleton and the muscle mesh at each skin vertex of the character is smallest, forming a virtual sphere around each skin vertex of the character, gradually increasing a radius of the sphere, stopping increasing the radius when a collision with the triangles of the skeleton and the muscle mesh occurs, taking the radius at this time as a thickness, storing a collision point to calculate a thickness between the skeleton and the muscle mesh at each skin vertex of the character, correcting the calculated thickness value using a painting unit, and using the corrected thickness value. The internal reference mesh is an internal threshold surface on which the skin is no longer sunken in representing the distortion of the character skin model. The internal reference mesh is invisible on a screen upon actual rendering and used for controlling a motion in animation.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram illustrating a character animation system according to an exemplary embodiment of the present invention;

FIG. 2a illustrates a character model with skin according to the present invention;

FIG. 2b illustrates a character model having no skin according to the present invention;

FIG. 3 illustrates an example of a character skin mesh and an internal reference mesh according to the present invention;

FIG. 4 illustrates a spring connection structure between a character skin mesh and an internal reference mesh connected to the character skin mesh according to the present invention;

FIG. 5 illustrates a shape when an external shock is vertically applied to a surface according to the present invention;

FIG. 6 illustrates a shape when an external shock is slantingly applied to a surface according to the present invention;

FIG. 7 illustrates a solid body to be applied to a character according to the present invention; and

FIG. 8 is a flowchart illustrating a character animation method according to a preferred embodiment of the present invention.

### DETAILED DESCRIPTION OF THE EMBODIMENTS

Hereinafter, preferred embodiments of the present invention will be described in detail with reference to the accompanying drawings so that they can be readily implemented by those skilled in the art.

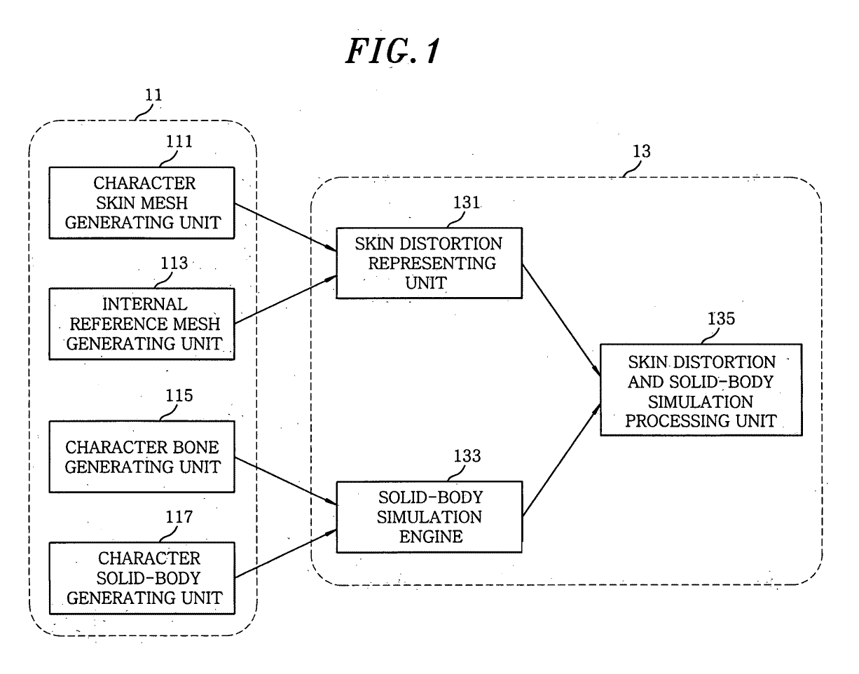

FIG. 1 is a block diagram illustrating a character animation system according to an exemplary embodiment of the present invention. The character animation system includes a data generating unit 11 and an animation processing unit 13.

The data generating unit 11 includes a character skin mesh generating unit 111, an internal reference mesh generating unit 113, a character bone generating unit 115, and a character solid-body generating unit 117.

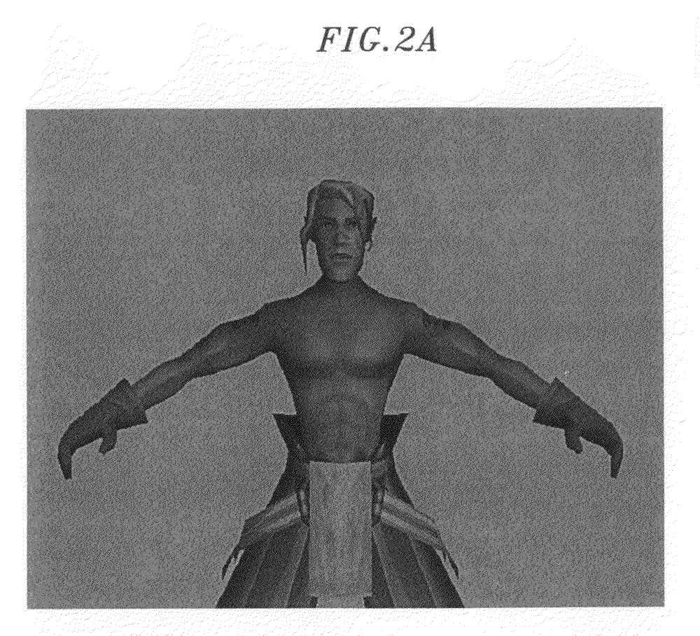

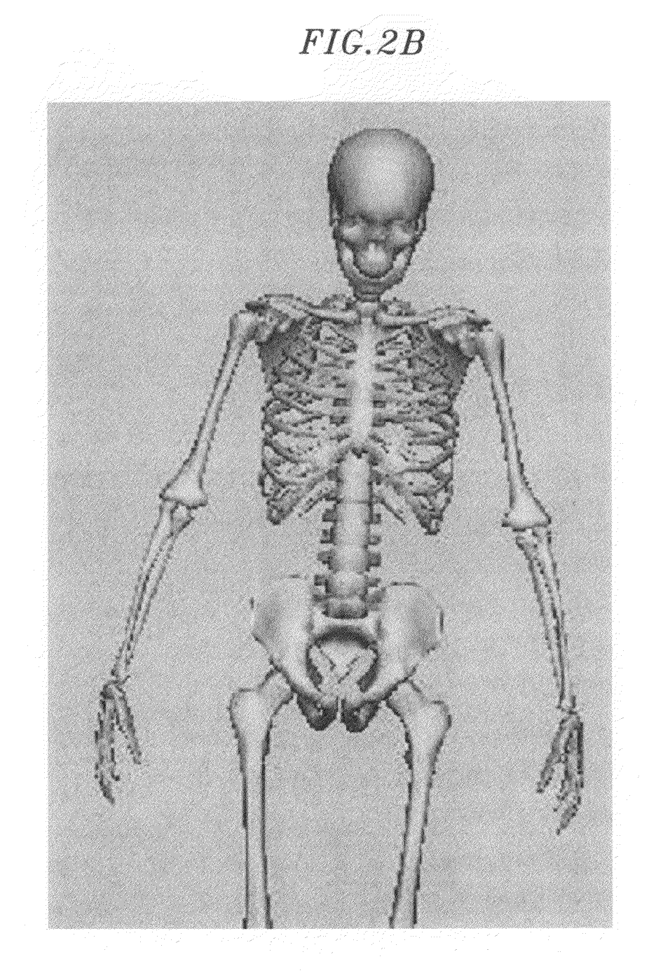

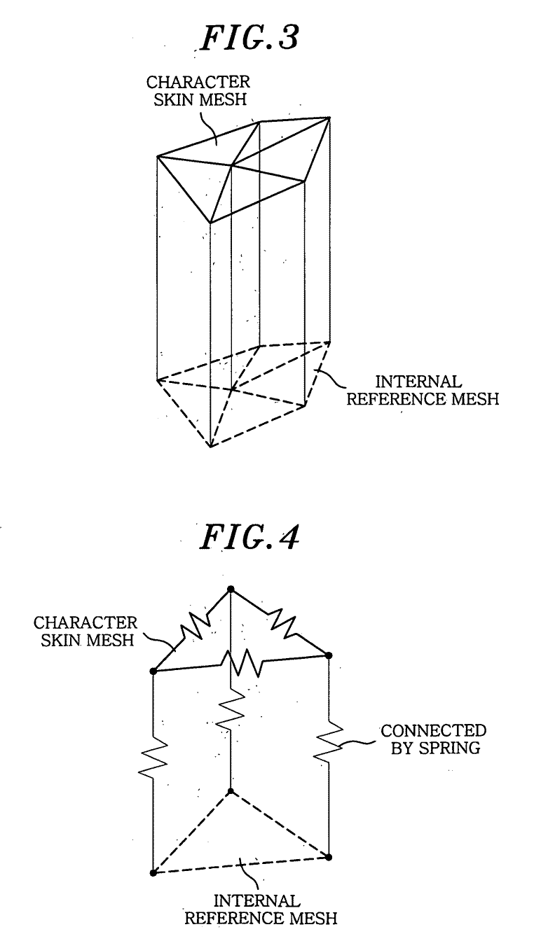

The character skin mesh generating unit 111 generates, for example, a character skin mesh as shown in FIG. 3 for each vertex of a character model with skin as shown in FIG. 2a, and provides the character skin mesh to a skin distortion representing unit 131 in the animation processing unit 13.

The internal reference mesh generating unit 113 matches the character skin model shown in FIG. 2a with a skeleton, a size of a muscle mesh, and a posture, discovers a point at which a distance between the skeleton and the muscle mesh at each skin vertex of the character is smallest (obtained by calculating a distance between each triangle of the skeleton and the muscle mesh, and the skin vertex). The internal reference mesh generating unit 113 then forms a virtual sphere around each skin vertex of the character, and gradually increases a radius of the sphere. When a collision with the triangles of the skeleton and the muscle mesh occurs, the internal reference mesh generating unit 113 stops increasing the radius, takes the radius at this time as a thickness, and stores a collision point to calculate a thickness between the skeleton and the muscle mesh at each skin vertex of the character. Fore example, as the thickness increases (e.g., as in abdomen), softer animation is feasible with sinking and protruding depths of the skin increased and as the thickness decrease (e.g., as in a face and a finger), distortion of the skin is small with sinking and protruding depths of the skin decreased. The internal reference mesh generating unit 113 then corrects the calculated thickness value using a 3D painting unit (e.g., a brush of a painting tool), generates the internal reference mesh as shown in FIG. 3 using the corrected thickness value, and provides the same to the skin distortion representing unit 131 in the animation processing unit 13. Here, the internal reference mesh is an internal threshold surface on which the skin is no longer sunken in representing the distortion of the character skin model, and is invisible on the screen upon actual rendering and used only for controlling a motion in animation.

The character bone generating unit 115 generates a character bone value of a character model having no skin as shown in FIG. 2b using, for example, 3D video MAX studio or Maya, and provides the character bone value to a solid-body simulation engine 133 in the animation processing unit 13.

The character solid-body generating unit 117 generates a character solid-body value of the character model having no skin as shown in FIG. 2b using a Havok plug-in program of the 3D video MAX studio or the Maya, and provides the character solid-body value to the solid-body simulation engine 133 in the animation processing unit 13.

The animation processing unit 13 includes the skin distortion representing unit 131, the solid-body simulation engine 133, and a skin distortion and solid-body simulation processing unit 135.

When an external shock is applied to the character in a state where key frame animation is activated, the skin distortion representing unit 131 represents the skin distortion using the character skin mesh for each vertex from the character skin mesh generating unit 111 and the internal reference mesh from the internal reference mesh generating unit 113.

That is, the skin distortion representing unit 131 operates based on a distance between the vertex of the character skin mesh and a corresponding vertex of the internal reference mesh. When the distance is long (e.g., when a thickness for skin distortion is great, as in abdomen), the skin distortion representing unit 131 represents the skin distortion by much accepting a skin distortion force and decreasing the size of force applied to solid-body simulation. On the other hand, when the distance is short (e.g., when the thickness for skin distortion is small, as in a face or a finger), the skin distortion representing unit 131 represents the skin distortion by less accepting the skin distortion force and increasing the size of the force applied to the solid-body simulation. Namely, the skin distortion representing unit 131 operates in proportion to the distance.

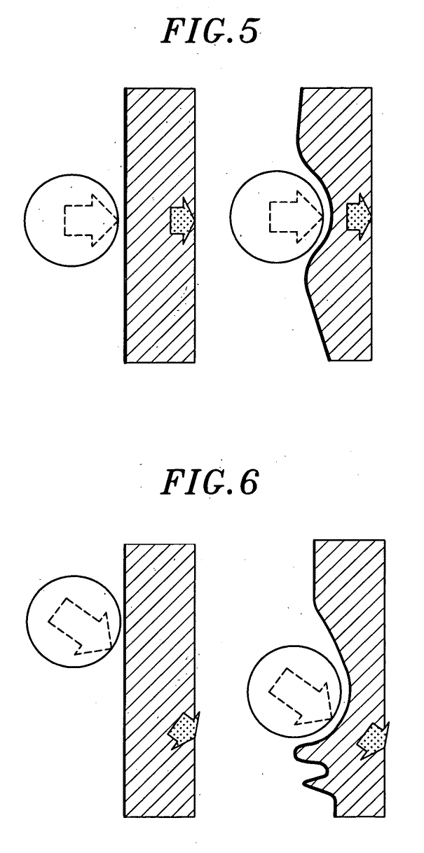

In other words, the skin distortion representing unit 131 has a spring structure as shown in FIG. 4 in which the edges between the vertexes of the internal reference mesh and the vertexes of the character skin mesh and between the skin vertexes are spring. The skin distortion representing unit 131 represents, through animation, the skin distortion, such as a laterally shoved skin, a sunken skin, a stretched skin, and the like, as shown in FIGS. 5 and 6, and provides the same to the skin distortion and solid-body simulation processing unit 135. Here, respective edges (including the edges connected to the internal reference model) have a predetermined spring constant. An initial mesh shape is considered as a stable state.

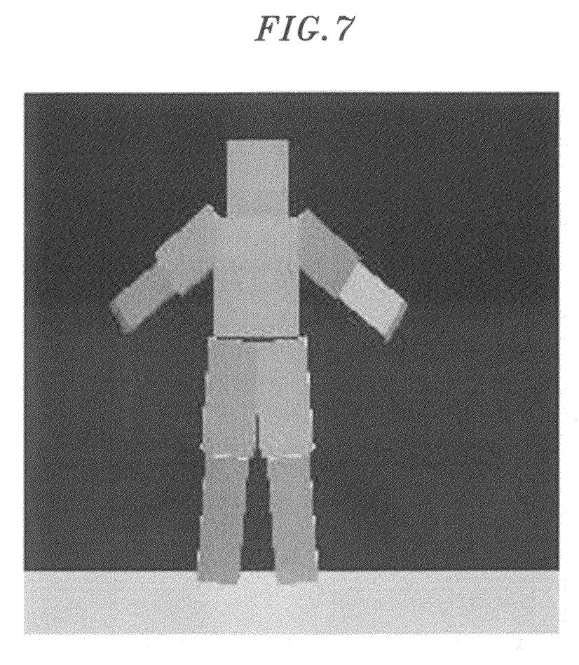

The solid-body simulation engine 133 applies the character bone value from the character bone generating unit 115 and the character solid-body value from the character solid-body generating unit 117 to a real-time physical simulation library such as ODE, Havok, Physics X, and the like to represent character solid-body simulation, and provides the character solid-body simulation to the skin distortion and solid-body simulation processing unit 135. The character solid-body simulation includes the solid body of the character as shown in FIG. 7 and imposes limiting points to joint rotation. The character solid-body simulation takes a location, strength, and direction of the force, as inputs.

When the skin distortion is input from the skin distortion representing unit 131 and the character solid-body simulation is input from the solid-body simulation engine 133, the skin distortion and solid-body simulation processing unit 135 processes to return to a key frame to be newly applied.

That is, for real time representation, the skin distortion and solid-body simulation processing unit 135 represents weighted blending between the character solid-body simulation and the key frame by Equation 1:

### Equation 1

Ani(Character, t)=W(t)*Ani(solid-body simulation, t)+(1−W(t))*Ani(key frame, t),

where W(t) is a weight of the character solid-body simulation at a time t, and (1-W(t)) is a weight of the key frame animation at a time t. And, Ani(Character, t) is the character's animation at a time t, Ani(solid-body simulation, t) is the animation of the character solid-body simulation at a time t, and Ani(key frame, t) is the animation of the key frame at a time t.

Upon weighted blending, the skin distortion and solid-body simulation processing unit 135 blends rotation values of respective joints using Spherical Linear interpolation (hereinafter, SLERP) with a weight, and blends location values through linear interpolation of the weight.

When performing the character solid-body simulation and then returning to a key frame to be newly applied, the skin distortion and solid-body simulation processing unit 135 gradually changes the weight W(t) from 1.0 to 0.0 at start and end portions of the blended portion in the solid-body simulation portion.

Thus, according to the present invention, an external shock, when applied, is reflected to real-time character animation. Skin distortion can be represented using the internal reference mesh, and animation, including simple animation of an object returning to its original posture after being struck, can be represented in real time using Ragdoll simulation and key frame interpolation. Accordingly, physical phenomenon as well as skin distortion can be naturally represented. The present invention may be applied to a whole body of the character, as well as its face.

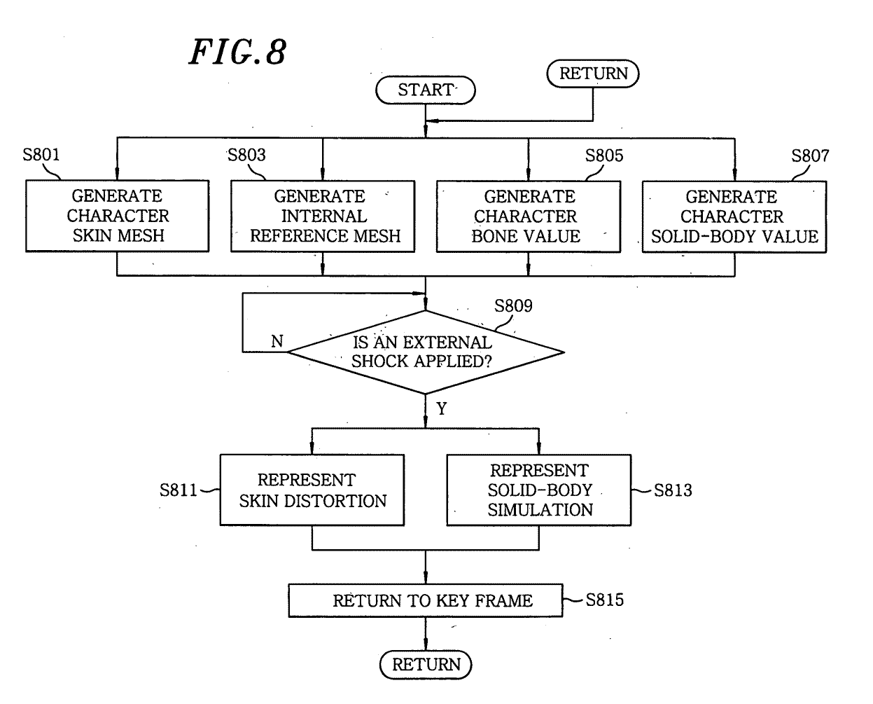

FIG. 8 is a flowchart illustrating a character animation method according to an exemplary embodiment of the present invention.

First, the character skin mesh generating unit 111 generates, for example, a character skin mesh as shown in FIG. 3 for each vertex of a character model with skin as shown in FIG. 2a (S801), and provides the character skin mesh to the skin distortion representing unit 131.

The internal reference mesh generating unit 113 then matches a skeleton, a size of a muscle mesh, and a posture with the character skin model shown in FIG. 2a, discovers a point at which a distance between the skeleton and the muscle mesh at each skin vertex of the character is smallest (obtained by calculating a distance between each triangle of the skeleton and the muscle mesh, and the skin vertex). The internal reference mesh generating unit 113 then forms a virtual sphere around each skin vertex of the character, and gradually increases a radius of the sphere. When a collision with the triangles of the skeleton and the muscle mesh occurs, the internal reference mesh generating unit 113 stops increasing the radius, takes the radius at this time as a thickness, and stores a collision point to calculate a thickness between the skeleton and the muscle mesh at each skin vertex of the character. For example, as the thickness increases (e.g., as in abdomen), softer animation is feasible with sinking and protruding depths of the skin increased while as the thickness decrease (e.g., as in a face and a finger), distortion of the skin is small with sinking and protruding depths of the skin decreased.

The internal reference mesh generating unit 113 then corrects the calculated thickness value using a 3D painting unit (e.g., a brush of a painting tool), generates the internal reference mesh as shown in FIG. 3 using the corrected thickness value (S803), and provides the same to the skin distortion representing unit 131 in the animation processing unit 13. Here, the internal reference mesh is an internal threshold surface on which the skin is no longer sunken in representing the distortion of the character skin model, and is invisible on the screen upon actual rendering and used only for controlling a motion in animation.

The character bone generating unit 115 then generates a character bone value of a character model having no skin as shown in FIG. 2b (S805) and provides the character bone value to the solid-body simulation engine 133. The character solid-body generating unit 117 generates a character solid-body value of the character model having no skin as shown in FIG. 2b (S807) and provides the character solid-body value to the solid-body simulation engine 133.

The skin distortion representing unit 131 then determines whether an external shock is applied to the character in a state where key frame animation is activated (S809).

If it is determined in S809 that an external shock is not applied, the skin distortion representing unit 131 continues to determine whether an external shock is applied. If it is determined in S809 that an external shock is applied, the skin distortion representing unit 131 represents the skin distortion using the character skin mesh for each vertex from the character skin mesh generating unit 111 and the internal reference mesh from the internal reference mesh generating unit 113.

That is, the skin distortion representing unit 131 operates based on a distance between the vertex of the character skin mesh and a corresponding vertex of the internal reference mesh. When the distance is long (e.g., when a thickness for skin distortion is great, as in abdomen), the skin distortion representing unit 131 represents the skin distortion by much accepting a skin distortion force and decreasing the size of force applied to solid-body simulation. On the other hand, when the distance is short (e.g., when the thickness for skin distortion is small, as in a face or a finger), the skin distortion representing unit 131 represents the skin distortion by less accepting the skin distortion force and increasing the size of the force applied to the solid-body simulation.

In other words, the skin distortion representing unit 131 has a spring structure as shown in FIG. 4 between the vertex of the internal reference mesh and the vertex of the character skin mesh and between the skin vertexes. The skin distortion representing unit 131 represents, through animation, the skin distortion, such as laterally shoved skin, sunken skin, stretched skin, and the like (S811), as shown in FIGS. 5 and 6, and provides the same to the skin distortion and solid-body simulation processing unit 135. Here, respective edges (including the edges connected to the internal reference model) have a predetermined spring constant. An initial mesh shape is considered as a stable state.

When an external shock is applied to the character in a state where key frame animation is activated, the solid-body simulation engine 133 then applies the character bone value from the character bone generating unit 115 and the character solid-body value from the character solid-body generating unit 117 to a real-time physical simulation library such as ODE, Havok, Physics X, and the like to represent character solid-body simulation (S813), and provides the character solid-body simulation to the skin distortion and solid-body simulation processing unit 135. The character solid-body simulation includes the solid body of the character as shown in FIG. 7 and imposes limiting points to joint rotation. The character solid-body simulation takes a location, strength, and direction of the force, as inputs.

When the skin distortion is input from the skin distortion representing unit 131 and the character solid-body simulation is input from the solid-body simulation engine 133, the skin distortion and solid-body simulation processing unit 135 processes to return to a key frame to be newly applied (S815).

That is, the skin distortion and solid-body simulation processing unit 135 represents weighted blending between the character solid-body simulation and the key frame by Equation 1 for real time representation and, upon weighted blending, blends rotation values of respective joints using SLERP with a weight, and blends location values through linear interpolation of the weight.

In other words, when performing the character solid-body simulation and then returning to a key frame to be newly applied, the skin distortion and solid-body simulation processing unit 135 gradually changes the weight W(t) from 1.0 to 0.0 at start and end portions of the blended portion in the solid-body simulation portion.

Accordingly, the present invention involves reflecting an external shock (due to striking with a fist, kicking, shooting, or the like), when applied, to real-time character animation.

And, according to the present invention, an external shock, when applied, is reflected to real-time character animation. Skin distortion can be represented using the internal reference mesh, and animation, including simple animation of an object returning to its original posture after being struck, can be represented in real time. Thus, the internal reference mesh can be easily generated and used for skin distortion animation. The real-time animation is feasible with less computational complexity, and after returning to the key frame character control can be performed, instead of simply ending with the solid-body animation.

Furthermore, according to the present invention, a physical phenomenon as well as skin distortion can be naturally represented. The present invention may be applied to a whole body of the character, as well as its face.

While the invention has been shown and described with respect to the embodiments, it will be understood by those skilled in the art that various changes and modifications may be made without departing from scope of the invention as defined in the following Claims.

What is claimed is:

1. A character animation system comprising:
a data generating unit for generating a character skin mesh and an internal reference mesh, a character bone value, and a character solid-body value;
a skin distortion representing unit for representing skin distortion using the generated character skin mesh and the internal reference mesh when an external shock is applied to a character; and
a solid-body simulation engine for applying the generated character bone value and the character solid-body value to a real-time physical simulation library and representing character solid-body simulation.

2. The system of claim 1, further comprising a skin distortion and solid-body simulation processing unit for processing to return to a key frame to be newly applied after the skin distortion and the solid-body simulation are represented.

3. The system of claim 2, wherein the skin distortion and solid-body simulation processing unit represents weighted blending between the character solid-body simulation and the key frame for real time representation by an equation:
Ani(Character, t)=W(t)*Ani(solid-body simulation, t) +(1−W(t))*Ani(key frame, t),
where W(t) is a weight of the character solid-body simulation at a time t, and (1−W(t)) is a weight of the key frame animation at a time t, and upon weighted blending, the skin distortion and solid-body simulation processing unit blends rotation values of respective joints using Spherical Linear interpolation (SLERP) with a weight, and blends location values through linear interpolation of the weight.

4. The system of claim 1, wherein the skin distortion representing unit has a spring structure in which edges between a vertex of the internal reference mesh and a vertex of the character skin mesh and between vertexes of the character skin mesh are spring, and represents laterally shoved skin, sunken skin, and stretched skin through animation.

5. The system of claim 4, wherein the edges have a predetermined spring constant and an initial mesh shape is regarded as a stable state.

6. The system of claim 1, wherein the skin distortion representing unit operates in proportion to a distance between a vertex of the character skin mesh and a corresponding vertex of the internal reference mesh, and represents the skin distortion by much accepting a skin distortion force and decreasing the size of force applied to solid-body simulation when the distance is long and by less accepting the skin distortion force and increasing the size of the force applied to the solid-body simulation when the distance is short.

7. The system of claim 1, wherein the internal reference mesh is generated by matching the character with a skeleton, a size of a muscle mesh, and a posture, discovering a point at which a distance between the skeleton and the muscle mesh at each skin vertex of the character is smallest, forming a virtual sphere around each skin vertex of the character, gradually increasing a radius of the sphere, stopping increasing the radius when a collision with the triangles of the skeleton and the muscle mesh occurs, taking the radius at this time as a thickness, storing a collision point to calculate a thickness between the skeleton and the muscle mesh at each skin vertex of the character, correcting the calculated thickness value using a painting unit, and using the corrected thickness value.

8. The system of claim 1, wherein the internal reference mesh is an internal threshold surface on which the skin is no longer sunken in representing the distortion of the character skin model.

9. The system of claim 1, wherein the internal reference mesh is invisible on a screen during actual rendering and used for controlling a motion in animation.

10. The system of claim 1, wherein the character solid-body simulation includes the solid body of the character and imposes limiting points to joint rotation.

11. The system of claim 1, wherein the character solid-body simulation takes a location, strength, and direction of force, as inputs.

12. A character animation method, comprising:
generating a character skin mesh for each vertex of the character;
generating an internal reference mesh of a character;
generating a bone value of the character;
generating a solid body value of the character;
representing skin distortion using the generated character skin mesh and the generated internal reference mesh;
applying the generated character bone value and the generated character solid-body value to a real-time physical simulation library to represent character solid-body simulation; and
processing to return to a key frame to be newly applied after representing the skin distortion and the solid-body simulation.

13. The method of claim 12, wherein the internal reference mesh is generated by matching the character with a skeleton, a size of a muscle mesh, and a posture, discovering a point at which a distance between the skeleton and the muscle mesh at each skin vertex of the character is smallest, forming a virtual sphere around each skin vertex of the character, gradually increasing a radius of the sphere, stopping increasing the radius when a collision with the triangles of the skeleton and the muscle mesh occurs, taking the radius at this time as a thickness, storing a collision point to calculate a thickness between the skeleton and the muscle mesh at each skin vertex of the character, correcting the calculated thickness value using a painting unit, and using the corrected thickness value.

14. The method of claim 12, wherein the internal reference mesh is an internal threshold surface on which the skin is no longer sunken in representing the distortion of the character skin model.

15. The method of claim 12, wherein the internal reference mesh is invisible on a screen upon actual rendering and used for controlling a motion in animation.
